(19) United States
(12) Patent Application Publication
(10) Pub. No.: US 2023/0055270 A1
(43) Pub. Date: Feb. 23, 2023

(54) FREE SPACE OPTICAL COMMUNICATION TERMINAL AND METHOD

(71) Applicant: Airbus (S.A.S.), Blagnac (FR)

(72) Inventors: Ricardo Barrios, Blagnac (FR); Jan Tepper, München (DE); Alberto Comin, München (DE)

(21) Appl. No.: 17/888,791

(22) Filed: Aug. 16, 2022

(30) Foreign Application Priority Data
Aug. 23, 2021 (EP) 21192652.2

(51) Int. Cl. H04B 10/112; H04B 10/61; H04B 10/67; H04B 10/50

(52) U.S. Cl. CPC H04B 10/1123; H04B 10/614; H04B 10/675; H04B 10/503

(57) ABSTRACT

In order to improve free space optical communications, an optical communication terminal includes a laser source, a photo detecting apparatus and an optical input/output assembly. These components are controlled by a control logic. In order to have the optical communication terminal to be self-compatible, the optical input/output assembly selectively routes the outgoing beam and incoming beam depending on their respective beam polarization. To this end, the optical input/output assembly may include a polarizing beam splitter together with a quarter-wave plate.

### CROSS-REFERENCE TO RELATED APPLICATION

This application claims priority to EP 21192652.2 filed Aug. 23, 2021, the entire disclosure of which is incorporated by reference herein.

### TECHNICAL FIELD

The disclosure herein relates to a free space optical communication terminal and an associated method.

### BACKGROUND

In optical comms it is common to have different terminals at the two sides of a communication link. The reason is that in typical scenarios, such as light ground-satellite or ground-aircraft links, the two communication partners are very different. Additionally, the propagation through atmosphere may affect the uplink and downlink differently due to turbulence strength decrease at higher altitudes above ground. The issue may arise in meshed networks between identical partners, e.g. an aircraft-aircraft network, typically because designing an optical terminal which is compatible with itself is rather challenging. In a communication link, one terminal transmits using one channel (e.g. a specific wavelength) and receives using another channel (i.e. a different specific wavelength); the roles of the two channels are switched for the second terminal. This is the same situation as for common serial cables, where there is one Rx and one Tx wire, and, to communicate between two devices one needs either to swap the Rx and Tx wires inside the cable (the twisted cable) or have different types of serial ports on the two devices. Since there is no possibility to swap the Rx and Tx channels within the atmosphere, different terminals on each side of the link are commonly used.

### SUMMARY

It is an object of the disclosure herein to improve free space optical communications terminals to be self-compatible.

The disclosure herein provides a free space optical communication terminal configured for establishing an optical link to another communication terminal through free space, the free space optical communication terminal comprising:
a laser source that is configured for generating an outgoing beam of outgoing laser pulses, wherein the outgoing beam is to be transmitted from the laser source via free space to the other communication terminal;
a photo detecting apparatus that is configured for detecting an incoming beam of incoming laser pulses, wherein the incoming beam is incoming from the other communication terminal;
an optical input/output assembly that is configured for selectively routing the incoming beam and the outgoing beam based on their respective beam polarization such that the incoming beam is routed to the photo detecting apparatus and the outgoing beam is routed from the laser source towards free space; and
a control logic that is operatively coupled to the laser source, the photo detecting apparatus and/or the optical input/output assembly.

Preferably, the optical input/output assembly includes a beam splitter that is configured such that the outgoing beam is routed from the laser source towards free space and that the incoming beam is routed from free space towards the photo detecting apparatus depending on the respective beam polarization.

Preferably, the outgoing beam is reflected by the beam splitter. Preferably, the laser source generates the outgoing beam with s-polarization. Preferably, the beam splitter reflects s-polarization. Preferably, the incoming beam is transmitted by the beam splitter. Preferably, the beam splitter transmits p-polarization. Preferably, the beam splitter includes a polarizing beam splitter. Preferably, the optical input/output assembly includes a plurality of stacked polarizing elements that are arranged along the incoming beam direction before the beam splitter. Preferably, the optical input/output assembly includes a polarization isolator, such as a Faraday isolator, that is arranged along the outgoing beam direction, before the beam splitter.

Preferably, the laser source is configured for generating the outgoing beam with linear polarization, wherein the optical input/output assembly is configured for changing an outgoing beam polarization from a first linear polarization to a first elliptical or circular polarization and for changing an incoming beam polarization from a second elliptical or circular polarization to a second linear polarization, wherein the second linear polarization is different from the first linear polarization.

Preferably the first and second linear polarizations are orthogonal to each other. Preferably, the first and second elliptical or circular polarizations are opposite to each other.

Preferably, the optical input/output assembly includes a polarization changer that is configured such that the outgoing beam polarization is changed from the first linear polarization to the first elliptical or circular polarization and that the incoming beam polarization is changed from the second elliptical or circular polarization to the second linear polarization.

Preferably, the polarization changer is arranged along the path of the outgoing beam after the beam splitter. Preferably, the polarization changer is arranged along the path of the incoming beam before the beam splitter. Preferably, the polarization changer is configured to change the outgoing beam polarization from s-polarization to the first elliptical or circular polarization. Preferably, the polarization changer changes s-polarization to the first circular polarization. Preferably, the polarization changer is configured to change the incoming beam polarization from the second elliptical or circular polarization to p-polarization. Preferably, the polarization changer includes a quarter-wave plate.

Preferably, the optical link includes a plurality of channels that are defined by different central wavelengths of the laser pulses, wherein the laser source is configured to generate the outgoing beam having laser pulses with different central wavelengths. Preferably, the optical link includes a plurality of channels that are defined by different central wavelengths, wherein the same channel is configured as a Tx channel and an Rx channel, wherein the Tx channel and the Rx channel are isolated due to the respective beam polarization.

Preferably, the photo detecting apparatus comprises a photo detector and a tunable wavelength filter that is arranged along the path of the incoming beam before the photo detector, wherein the tunable wavelength filter is configured to allow passage of a tunable spectral window of wavelengths. Preferably, the tunable wavelength filter includes a tunable bandpass filter.

Preferably, the optical input/output assembly includes another tunable wavelength filter that is arranged along the path of the outgoing beam before free space, wherein the other tunable wavelength filter is configured to allow passage of a tunable spectral window of wavelengths. Preferably, the other tunable wavelength filter includes a tunable bandpass filter.

Preferably, the laser source includes a laser booster amplifier that is configured to operate in saturation mode, in order to amplify the outgoing laser pulses. Preferably, the laser booster amplifier is a fiber amplifier.

Preferably, the photo detecting apparatus includes a laser pre-amplifier that is configured to operate in low-noise mode, in order to amplify the incoming laser pulses while adding a minimum of noise. Preferably, the laser pre-amplifier is a fiber amplifier.

Preferably, the optical communication terminal further comprises a radio frequency transceiver that is operatively coupled to the control logic for enabling handshake with the other communication terminal.

The disclosure herein provides a free space optical communications arrangement comprising a first free space optical communication terminal and a second free space optical communication terminal, wherein both terminals are configured as described before.

The disclosure herein provides a free space optical communication method between a first free space optical communication terminal and a second free space optical communication terminal that are configured as described above, the method comprising:
generating an outgoing beam of outgoing laser pulses, wherein the outgoing beam is to be transmitted via free space to the second free space optical communication terminal;
detecting an incoming beam of incoming laser pulses, wherein the incoming beam is the outgoing beam that is incoming from the first free space optical communication terminal;
selectively routing the incoming beam to the photo detecting apparatus or the outgoing beam from the laser source towards free space based on their respective beam polarization.

Preferably, the outgoing beam is reflected towards free space and the incoming beam is transmitted from free space by a beam splitter.

Preferably, the laser source generates the outgoing beam with linear polarization and the optical input/output assembly changes an outgoing beam polarization from a first linear polarization to a first elliptical or circular polarization and changes an incoming beam polarization from a second elliptical or circular polarization to a second linear polarization, wherein the second linear polarization is different from the first linear polarization.

Preferably, the laser source generates the outgoing beam having laser pulses with a different central wavelength for each channel of the optical link, and in the photo detecting apparatus a tunable wavelength filter is tuned to allow passage of a tunable spectral window of wavelengths of the incoming beam.

Preferably, the optical input/output assembly includes another tunable wavelength filter that is tuned to allow passage of a tunable spectral window of wavelengths of the outgoing beam.

Preferably, the outgoing beam is amplified by a laser booster amplifier that operates in saturation mode.

Preferably, the incoming beam is amplified by a laser pre-amplifier that operates in low-noise mode, so that the incoming laser pulses are amplified with a minimum of noise.

Preferably, a handshake between both terminals is performed by a radio transmission.

One idea to achieve the object is to duplicate functionality, e.g. both terminals can receive and transmit at two different wavelengths. This can be accomplished by duplicating the number of transceivers of SFP modules. Another idea is to implement a reconfigurable terminal, so that one terminal can be switched between a first configuration, in which it transmits using a first wavelength and receive using a second wavelength, and a second configuration, in which the terminal transmits at the second wavelength and receives at the first wavelength.

In contrast to these solutions, the disclosure herein provides a less expensive, lower parts and more reliable solution. The disclosure herein provides a way to implement a terminal which can be easily reconfigured to be able to communicate with an identical version of itself. The terminal can be deployed on aircraft or satellites to realize an airborne meshed network, which is flexible where links can be dynamically established between each pair of aircraft.

Here, the way to implement a reconfigurable terminal which can link to an identical version of itself is by using a combination of wavelength and polarization to distinguish between the Rx and the Tx channels. The light polarization is used to distinguish between the communications modes: in the first mode the terminal transmits e.g. right-handed circular polarized light and receives left-handed circular polarized light, and vice versa in the second mode. Switching between the two modes is done by rotating a quarter-wave plate by 90° or, alternatively, a half-wave plate positioned before a static quarter-lambda. The benefit of this scheme is that it allows separating the Rx and Tx beams inside the terminal using a polarizing beam splitter. It is also compatible with wavelength multiplexing.

Each terminal can have the capability to change wavelength in Tx and Rx. There is a one-to-one correspondence between the wavelength and polarization which are used for receiving or transmitting. For example, assuming 20 channels at different wavelengths λ₁ to λ₂₀ the first terminal may transmit at λ₁ to λ₁₀ using right-handed circular polarization and receive at wavelengths λ₁₁ to λ₂₀ which has left-handed circular polarization; the opposite is applicable for terminal 2. The wavelength changing can be done using control logic that is preferably implemented using an FPGA. In the above example, each terminal carries 20 SFP-modules. All Tx ports are muxed together and all Rx incoming channels are demuxed in order to connect the respective SFP port. Depending on the modes, only one of the halves of the SFP modules are used for transmission. A tunable bandpass in the Rx chain may be selected accordingly for further improving Tx/Rx isolation.

The rotation of the optical axis of the quarter-wave plate can be done either mechanically or electronically (e.g. using liquid crystals).

Which terminals use which wavelength/polarization (i.e. mode 1 or 2) can be communicated beforehand through a radiofrequency (RF) handshake. This can for instance be done by assigning a value to each terminal (alternatively may be computed from its GPS coordinates) and setting the terminal with higher value to mode 2 and the other to mode 1. It should be noted that for the sake of brevity and illustration not all terminal components are shown, in particular the fine-pointing assembly well known in the art is not shown.

A communications arrangement of two terminals usually involves the free space between the terminals and the beams propagating therein as well as optical fibers that are used within the terminal apart from the input/output assembly. The Tx ports of both terminals can be s-polarized while the Rx ports of both terminals can be p-polarized. Each terminal is able to transmit and to receive using a single wavelength or a plurality of wavelengths implemented by SFP modules controlled by FPGAs. The Tx path may comprise a multiplexer (MUX) and an Erbium doped fiber (EDFA) booster; the Rx path comprises a tunable band-pass filter, an EDFA pre-amplifier and a demultiplexer (DEMUX). The quarter-wave plate angle orientation with respect to the local reference system is preferably +45° for the upper and −45° for the lower terminal. This allows the upper terminal to transmit right-handed circular polarized light and receive left-handed circular polarized light, and vice-versa for the lower terminal. The separation in wavelength and the use of band-pass filters may be used to improve isolation between the Tx and Rx channels.

### BRIEF DESCRIPTION OF THE DRAWINGS

Embodiments of the disclosure herein are described in more detail with reference to the accompanying schematic drawings that are listed below:

FIG. 1 depicts an embodiment of a free space optical communications arrangement according to the disclosure herein; and

FIG. 2 depicts a spectrum used in the communications arrangement.

### DETAILED DESCRIPTION

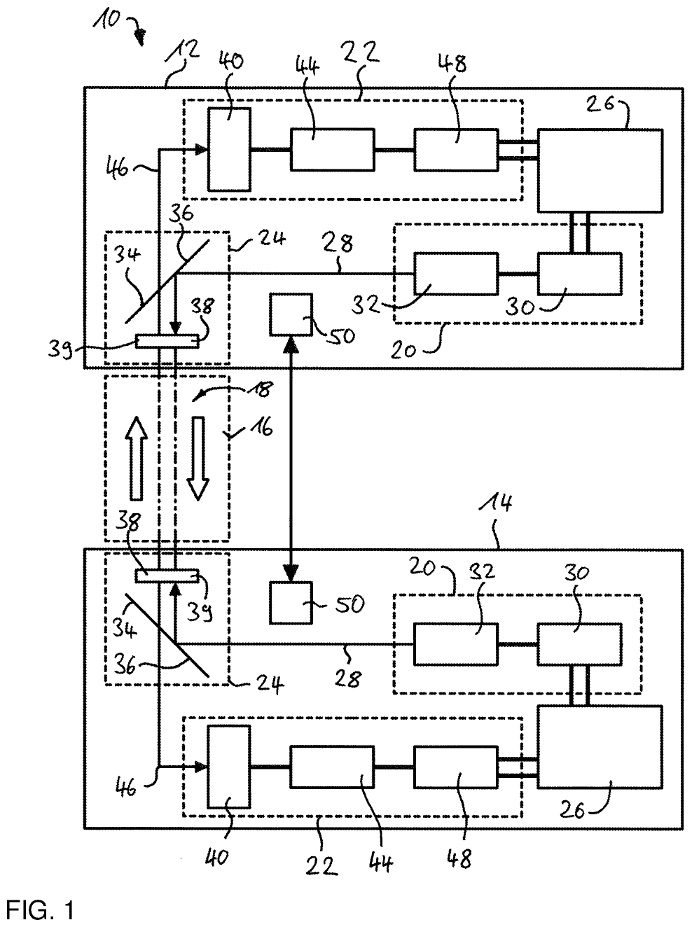

FIG. 1 illustrates an embodiment of a free space optical communication arrangement 10. The arrangement comprises a first optical communication terminal 12 and a second optical communication terminal 14. The first and second terminals 12, 14 are spaced apart with an area of free space 16 between them. The first and second terminals 12, 14 establish between themselves an optical link 18 via free space 16. The first and second optical communication terminals 12, 14 are configured identically with regard to their components so that for the sake of brevity only the first optical communication terminal 12 is described in more detail.

The first optical communication terminal 12 comprises a laser source 20, a photo detecting apparatus 22, an optical input/output assembly 24, and a control logic 26.

The control logic 26 is operatively coupled to the laser source 20, the detecting apparatus 22, and the optical input/output assembly 24 for controlling these devices.

The laser source 20 generates an outgoing beam 28. The laser source 20 includes a multiplexer 30 (MUX 30) that is coupled to the control logic 26. The MUX 30 generates laser pulses that are transferred to a laser booster amplifier 32. The laser booster amplifier 32 and the MUX 30 are connected to each other via an optical channel. The outgoing beam 28 propagates within the optical channel to the laser booster amplifier 32. The laser booster amplifier 32 is preferably operated in saturation mode, which means the outgoing laser pulses are preferably amplified to the saturated output power of the laser booster amplifier 32, e.g., an erbium doped fiber amplifier (EDFA).

The laser booster amplifier 32 emits the outgoing beam 28 which propagates further to the optical input/output assembly 24.

The optical input/output assembly 24 includes a beam splitter 34. The beam splitter 34 preferably includes a polarizing beam splitter 36. The beam splitter 34 is arranged so that the outgoing beam 28 is reflected toward free space 16.

The optical input/output assembly 24 includes a polarization changer 38, e.g., a quarter-wave plate 39. It is also possible that the polarization changer 38 includes instead of a passive element such as the quarter-wave plate 39, an active polarization changing element such as a photo elastic modulator or the like. The polarization changer 38 is configured such that a linear polarization is changed into a circular polarization.

The photo detecting apparatus 22 includes a tunable wavelength filter 40. The tunable wavelength filter 40 may include a tunable band pass filter. The tunable wavelength filter 40 is configured to allow passage of a spectral window 42 of wavelength. The position of the spectral window 42 in the wavelength domain is controlled by the control logic 26.

The photo detecting apparatus 22 includes a laser pre-amplifier 44. The laser pre-amplifier 44 is coupled to the tunable wavelength filter 40 via an optical fiber. The tunable wavelength filter 40 may be implemented by using a rotating filter or a linear translation stage with multiple filters. The laser pre-amplifier 44 may be again configured as a laser fiber amplifier similar to the laser booster amplifier 32. However, the laser pre-amplifier 44 is operated in low-noise mode. In low-noise mode, the gain of the laser pre-amplifier 44 is chosen such that the incoming beam 46 is merely amplified by the amount necessary for reliably detecting incoming beam 46, thereby avoiding an increase in noise.

The photo detecting apparatus 22 includes a demultiplexer 48 (DEMUX 48) that is coupled to the laser pre-amplifier 44 again via optical fiber. The demultiplexer 48 detects incoming laser pulses of the incoming beam 46 and transmits the signals to the control logic 26. The control logic 26 is preferably realized via a programmable logic circuit, such as an FPGA or a custom designed chip.

Furthermore, the first optical communication terminal 12 may include a radio frequency transceiver 50 (RF transceiver 50) that is used in a handshake between the first optical communication terminal 12 and the second optical communication terminal 14.

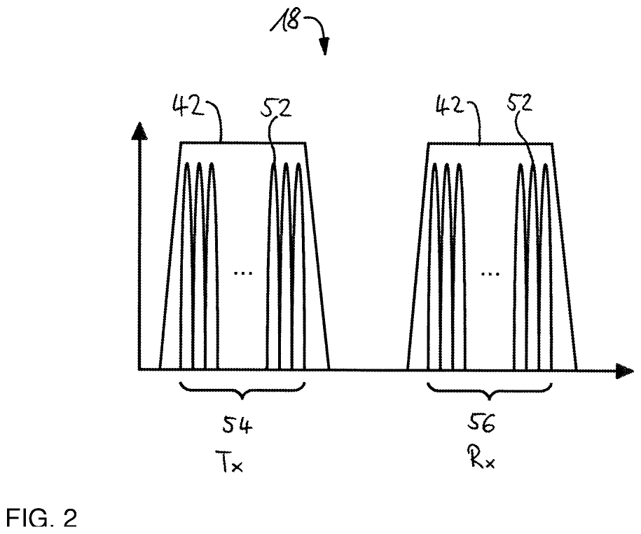

FIG. 2 depicts a typical spectrum that may be used in the communication arrangement 10. The diagram depicts on the horizontal axis wavelength and on the vertical axis intensity of the wavelengths or transmissivity of a wavelength filter (e.g. the spectral window 42 is illustrated).

As depicted schematically, the optical link 18 includes a plurality of channels 52. The channels 52 are separated into a first group 54 and a second group 56. The first group 54 may be the transmission channels Tx, while the second group 56 may be the receiving channels Rx with respect to the first optic. The diagram further depicts the spectral window 42 of the tunable wavelength filter 40 that suppresses any channels that are outside of the desired scope. In other words, the spectral window 42 is shifted towards the first group 54 or second group 56 depending on whether the first group 54 or the second group 56 is received by the second optical communication terminal 14 and vice versa.

The operation of the free space optical communication arrangement 10 will now be described in further detail with reference to both FIGS. 1 and 2.

Initially, the first and second optical communication terminals 12, 14 perform a handshake using the RF transceiver 50. With this handshake, the first and second optical communication terminals 12, 14 may define for example that the first group 54 of the channels 52 is used by the first optical communication terminal 12 as transmission channels Tx whereas group 56 of channels 52 are used as receiving channels Rx by the first optical communication terminal 12. The opposite is defined for the second optical communication terminal 14.

A message to be sent from the first optical communication terminal 12 to the second optical communication terminal 14 may be encoded by the control logic 26 which controls the MUX 30 to emit the outgoing beam 28 with laser pulses that are modulated according to the message to be sent. The outgoing beam 28 is propagating through a fiber to the laser booster amplifier 32 which amplifies the laser pulses of the outgoing beam 28. The laser pulses are polarized in s-polarization and propagate towards the optical input/output assembly 24. The beam splitter 34 reflects the outgoing beam 28 towards the polarization changer 38. The polarization changer 38 is controlled by the control logic 26 to change the outgoing beam polarization from linear polarization into circular polarization, such as right-handed circular polarization. Subsequently, the outgoing beam 28 leaves the first optical communication terminal 12 and propagates through free space 26 towards the second optical communication terminal 14.

After entering the second optical communication terminal 14, the now incoming beam 46 (with respect to the second optical communication terminal 14) enters the polarization changer 38 which turns the right-hand circular polarization into p-polarization. The incoming beam 46 subsequently travels to the beam splitter 34 and is transmitted by the beam splitter 34 towards the photo detecting apparatus 22.

When entering the photo detecting apparatus 22, the incoming beam 46 passes through a tunable wavelength filter 40 which has its spectral window 42 tuned such that all channels 52 of the first group 54 are allowed to pass, whereas all other wavelengths are suppressed. The incoming beam 46 passes through an optical fiber into the laser pre-amplifier 44. The laser pre-amplifier 44 amplifies the incoming laser pulses of the incoming beam 46 sufficiently that they can be detected by the DEMUX 48, but not much more in order to avoid an increase of noise. The amplified incoming beam 46 is passed through another fiber into the DEMUX 48 which detects the optical signals in the usual manner and the control logic 26 evaluates the received signals and outputs the message which was sent from the first optical communication terminal 12 to the second optical communication terminal 14.

Since both terminals are configured symmetrically, a second message can be transmitted from the second optical communication terminal 14 to the first optical communication terminal 12 simultaneously. As a result, the optical link 18 allows for a simultaneous bi-directional communication between the first and second optical communication terminals 12, 14.

In order to improve free space optical communications, the disclosure herein proposes an optical communication terminal 12 that includes a laser source 20, a photo detecting apparatus 22 and an optical input/output assembly 24. These components are controlled by a control logic 26. In order to have the optical communication terminal 12 to be self-compatible, the optical input/output assembly 24 selectively routes the outgoing beam 28 and incoming beam 46 depending on their respective beam polarization. To this end, the optical input/output assembly 24 may include a polarizing beam splitter 36 together with a quarter-wave plate 39.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 free space optical communication arrangement
12 first optical communication terminal
14 second optical communication terminal
16 free space
18 optical link
20 laser source
22 photo detecting apparatus
24 input/output assembly
26 control logic
28 outgoing beam
30 multiplexer (MUX)
32 laser booster amplifier
34 beam splitter
36 polarizing beam splitter
38 polarization changer
39 quarter-wave plate
40 tunable wavelength filter
42 spectral window
44 laser pre-amplifier
46 incoming beam
48 demultiplexer (DEMUX)
50 radio frequency transceiver (RF transceiver)
52 channel
54 first group
56 second group
Tx transmission channels
Rx receiving channels

1. A free space optical communication terminal configured for establishing an optical link to another communication terminal through free space, the free space optical communication terminal comprising:
a laser source configured for generating an outgoing beam of outgoing laser pulses, wherein the outgoing beam is to be transmitted from the laser source via free space to the other communication terminal;
a photo detecting apparatus configured for detecting an incoming beam of incoming laser pulses, wherein the incoming beam is incoming from the other communication terminal;
an optical input/output assembly configured for selectively routing the incoming beam and the outgoing beam based on their respective beam polarization such that the incoming beam is routed to the photo detecting apparatus and the outgoing beam is routed from the laser source towards free space; and
a control logic that is operatively coupled to the laser source, the photo detecting apparatus and/or the optical input/output assembly.

2. The optical communication terminal according to claim 1, wherein the optical input/output assembly includes a beam splitter configured such that the outgoing beam is routed from the laser source towards free space and such that the incoming beam is routed from free space towards the photo detecting apparatus depending on the respective beam polarization.

3. The optical communication terminal according to claim 1, wherein the laser source is configured for generating the outgoing beam with linear polarization, wherein the optical input/output assembly is configured for changing an outgoing beam polarization from a first linear polarization to a first elliptical or circular polarization and for changing an incoming beam polarization from a second elliptical or circular polarization to a second linear polarization, wherein the second linear polarization is different from the first linear polarization.

4. The optical communication terminal according to claim 3, wherein the optical input/output assembly includes a polarization changer configured such that the outgoing beam polarization is changed from the first linear polarization to the first elliptical or circular polarization and such that the incoming beam polarization is changed from the second elliptical or circular polarization to the second linear polarization.

5. The optical communication terminal according to claim 1, wherein the optical link includes a plurality of channels that are defined by different central wavelengths of the laser pulses, wherein the laser source is configured to generate the outgoing beam having laser pulses with different central wavelengths.

6. The optical communication terminal according to claim 1, wherein the photo detecting apparatus comprises a photo detector and a tunable wavelength filter that is arranged along a path of the incoming beam before the photo detector, wherein the tunable wavelength filter is configured to allow passage of a tunable spectral window of wavelengths.

7. The optical communication terminal according to claim 1, wherein the optical input/output assembly includes another tunable wavelength filter arranged along a path of the outgoing beam before free space, wherein the other tunable wavelength filter is configured to allow passage of a tunable spectral window of wavelengths.

8. The optical communication terminal according to claim 1, wherein the laser source includes a laser booster amplifier configured to operate in saturation mode, in order to amplify the outgoing laser pulses.

9. The optical communication terminal according to claim 1, wherein the photo detecting apparatus includes a laser pre-amplifier configured to operate in low-noise mode, in order to amplify the incoming laser pulses while adding a minimum of noise.

10. The optical communication terminal according to claim 1, further comprising a radio frequency transceiver operatively coupled to the control logic for enabling handshake with the other communication terminal.

11. A free space optical communications arrangement comprising a first free space optical communication terminal and a second free space optical communication terminal, wherein both terminals are configured according to claim 1.

12. A free space optical communication method between a first free space optical communication terminal and a second free space optical communication terminal, the method comprising:
providing a free space optical communication terminal configured for establishing an optical link to another communication terminal through free space, the free space optical communication terminal comprising:
a laser source configured for generating an outgoing beam of outgoing laser pulses, wherein the outgoing beam is to be transmitted from the laser source via free space to the other communication terminal;
a photo detecting apparatus configured for detecting an incoming beam of incoming laser pulses, wherein the incoming beam is incoming from the other communication terminal;
an optical input/output assembly configured for selectively routing the incoming beam and the outgoing beam based on their respective beam polarization such that the incoming beam is routed to the photo detecting apparatus and the outgoing beam is routed from the laser source towards free space; and
a control logic that is operatively coupled to the laser source,
the photo detecting apparatus and/or the optical input/output assembly;
generating an outgoing beam of outgoing laser pulses, wherein the outgoing beam is to be transmitted via free space to the second free space optical communication terminal;
detecting an incoming beam of incoming laser pulses, wherein the incoming beam is the outgoing beam that is incoming from the first free space optical communication terminal; and
selectively routing the incoming beam to the photo detecting apparatus or the outgoing beam from the laser source towards free space based on their respective beam polarization.

13. The method according to claim 12, wherein the outgoing beam is reflected towards free space and the incoming beam is transmitted from free space by a beam splitter.

14. The method according to claim 12, wherein the laser source generates the outgoing beam with linear polarization and the optical input/output assembly changes an outgoing beam polarization from a first linear polarization to a first elliptical or circular polarization and changes an incoming beam polarization from a second elliptical or circular polarization to a second linear polarization, wherein the second linear polarization is different from the first linear polarization.

15. The method according to claim 12, wherein the laser source generates the outgoing beam having laser pulses with a different central wavelength for each channel of the optical link, and in the photo detecting apparatus a tunable wavelength filter is tuned to allow passage of a tunable spectral window of wavelengths of the incoming beam.
